(19) United States
(12) Patent Application Publication
(10) Pub. No.: US 2002/0083050 A1
(43) Pub. Date: Jun. 27, 2002

(54) Client / server based dynamic information feedback system and method thereof

(76) Inventors: Yi Bo Liu, Tienchin (CN); Tong S. Chen, Taipei (TW); Kuang Shin Lin, Taipei (TW)

Correspondence Address: BIRCH STEWART KOLASCH & BIRCH, PO BOX 747, FALLS CHURCH, VA, 22040-0747, US

(21) Appl. No.: 09/742,130

(22) Filed: Dec. 22, 2000

(51) Int. Cl. G06F 7/00

(52) U.S. Cl. 707/3

(57) ABSTRACT

A client/server based dynamic information feedback system comprising: a client sender module, for collecting data and sending the data; a server receiving & analysis module, for receiving the data and analyzing the data; a server statistical & publishing module, for calculating the data and resulting in statistical data, then storing the statistical data into a database; and a client feedback receiving module, sending a request to the server end and causing feedback, then returning the feedback to the client end. A client/server based dynamic information feedback method comprising the steps of: (a) collecting data and sending the data from the client end; (b) receiving the data from the client end and analyzing the data on the server end; (c) calculating the data and resulting in statistical data, then storing the statistical data into a database on the server end; and (d) sending a request to the server end and causing feedback, then returning the feedback to the client end.

### BACKGROUND OF THE INVENTION

1. Field of the Invention

The present invention relates to dynamic information feedback, and more particularly to a client/server based dynamic information feedback system and method thereof.

2. Background

Data collection and feedback are very important in the manufacturing industry. For example, when the distributed testing sites perform testing jobs, one of the testing sites needs to provide its testing results and statistic data to others, further it needs to collect data provided from others for directing subsequent tasks. In order to accomplish the above objects, manual collecting data methods with email or FTP (File Transfer Protocol) are used. However, these methods have the following disadvantages: (1) The architecture of data management is a peer to peer model, thus a great deal of time and money is wasted collecting and transferring data on distributed sites. (2) The architecture of prior art is not client-server model, thus it is short of central management and security. (3) The efficiency of information feedback is bad and lack dynamic real-time updating and publishing. (4) The testing results need synchronous confirmation resulting in bad accuracy and efficiency. (5) The architecture of prior art can not return and direct all distributed sites with feedback information in real time.

The arts are inefficiency for big enterprises, especially those who have many benches. Collecting useful data can seriously impact a product's manufacturing cycle time.

### SUMMARY OF THE INVENTION

The object of the present invention is to solve the above-mentioned problems and to provide a client/server based dynamic information feedback system and method thereof.

According to the present invention, a client/server based dynamic information feedback system comprises: a client sender module, for collecting data and sending the data; a server receiver & analyst module, for receiving the data and analyzing the data; a server statistic & publisher module, for calculating the data and resulting in statistical data, then storing the statistical data into a database; and a client feedback receiving module, sending a request to the server end and causing feedback, then returning the feedback to the client end.

According to the present invention, a client/server based dynamic information feedback method comprises the steps of: (a) collecting data and sending the data from the client end; (b) receiving the data from the client end and analyzing the data on the server end; (c) calculating the data, resulting in a statistical data, then storing the statistical data into a database on the server end; and (d) sending a request to the server end and causing feedback, then returning the feedback to the client end.

### BRIEF DESCRIPION OF THE DRAWINGS

The present invention will be described in detail with reference to the illustrated embodiments and the accompany drawings, in which:

FIG. 1 is a block diagram of the client/server based dynamic information feedback system in this invention.

FIG. 2 is a flow chart showing the steps for the server receiver & analyst module of the system in this invention.

FIG. 3 is a flow chart showing the steps for the server statistic & publisher module of the system in this invention.

FIG. 4 is a flow chart showing the steps for the clientfeedback receiving module of the system in this invention.

FIG. 5 a frame showing a client end sending a querying request to a server end in this invention.

FIG. 6 a frame showing a server end sending a newest corresponding inquiry result to a client end in this invention.

### DETAILED DESCRIPTION OF THE INVENTION

A client/server based dynamic information feedback system according to the preferred embodiment of the present invention will now be described.

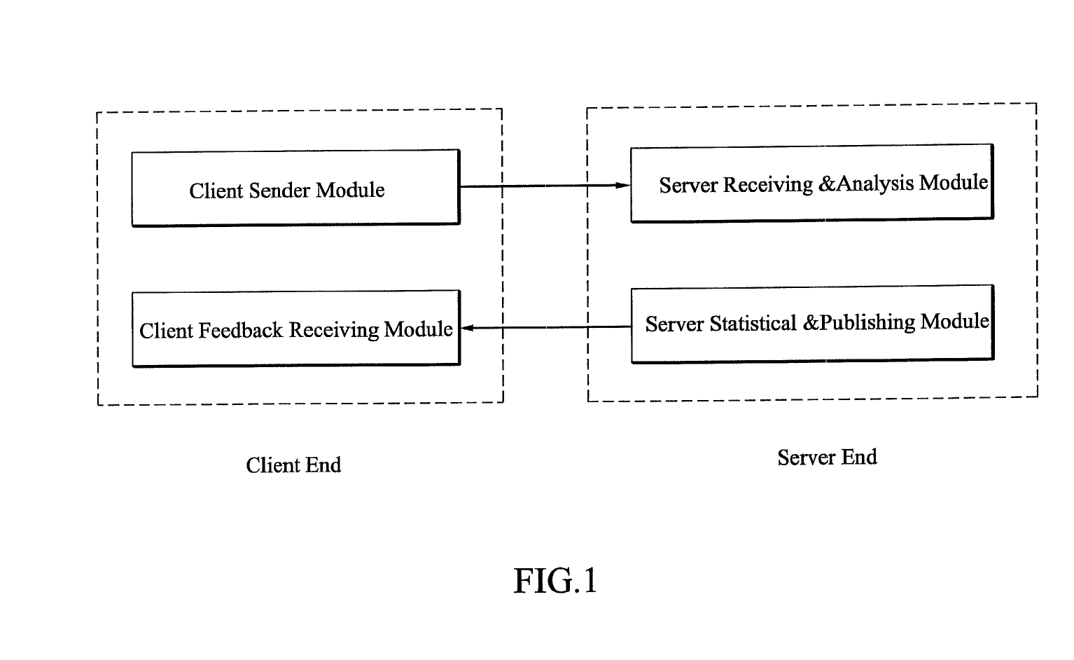

FIG. 1 is a block diagram of the client/server based dynamic information feedback system in the preferred embodiment. As shown in FIG. 1, the client/server based dynamic information feedback system includes two major parts, a server end and a client end, and four modules, a client sender module, a server receiving & analysis module, a server statistical & publishing module and a clientfeedback receiving module. The relations between four modules are: the client sender module collects data and sends the data; the server receiving & analysis module receives the data, then analyzes the data; the server statistical & publishing module calculates the data and results in statistical data, then stores the statistical data into a database; and a client feedback receiving module sends a request to the server end and causes feedback, then returns the feedback to the client end.

Each module will now be explained:

The client sender module collects data, and sends the data to server end with I-SQL function of a SQL (Structured Query Language) server.

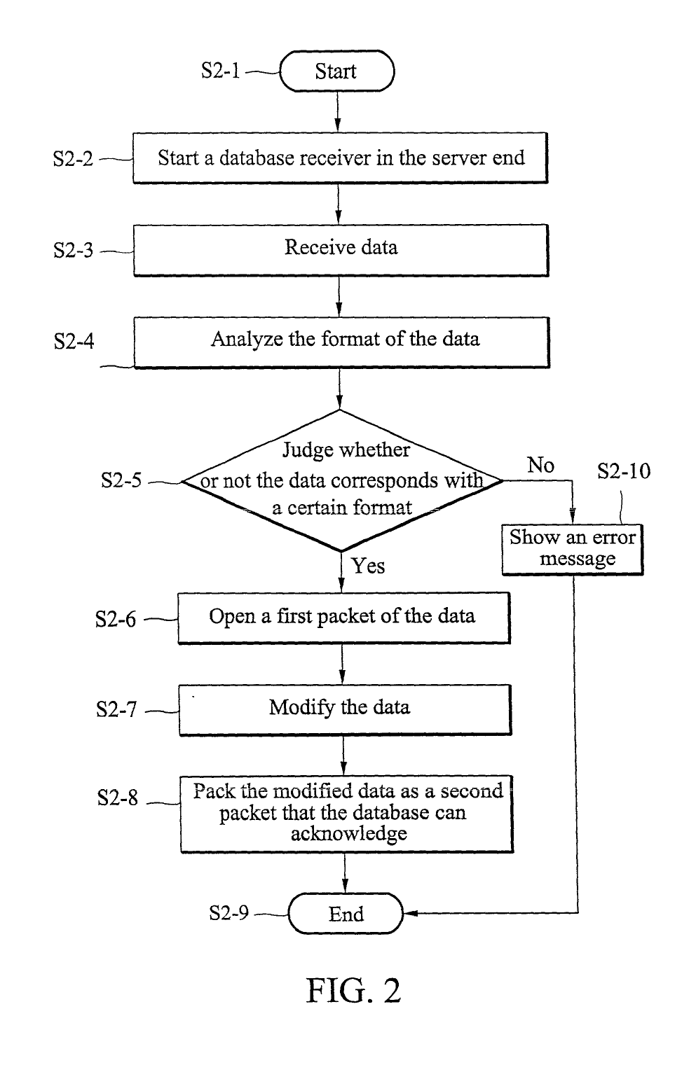

Referring to FIG. 2 a flow chart showing the steps for the server receiving & analysis module of the system in this invention is illustrated. The server receiving & analysis module first starts a database receiver in the server end, as shown in step S2-2.

In step S2-3, the server receiving & analysis module receives data.

In step S2-4, the server receiving & analysis module analyzes the format of the data.

In step S2-5, the server receiving & analysis module judges whether or not the data corresponds with a certain format. If the data corresponds with the certain format, the server receiving & analysis module will execute step S2-6; otherwise execute step S2-10 to show an error message.

In step S2-6, the server receiving & analysis module opens a first packet of the data.

In step S2-7, the server receiving & analysis module modifies the data.

In step S2-8, the server receiving & analysis module packs the modified data as a second packet that the database can acknowledge.

In step S2-9, the server receiving & analysis module terminates.

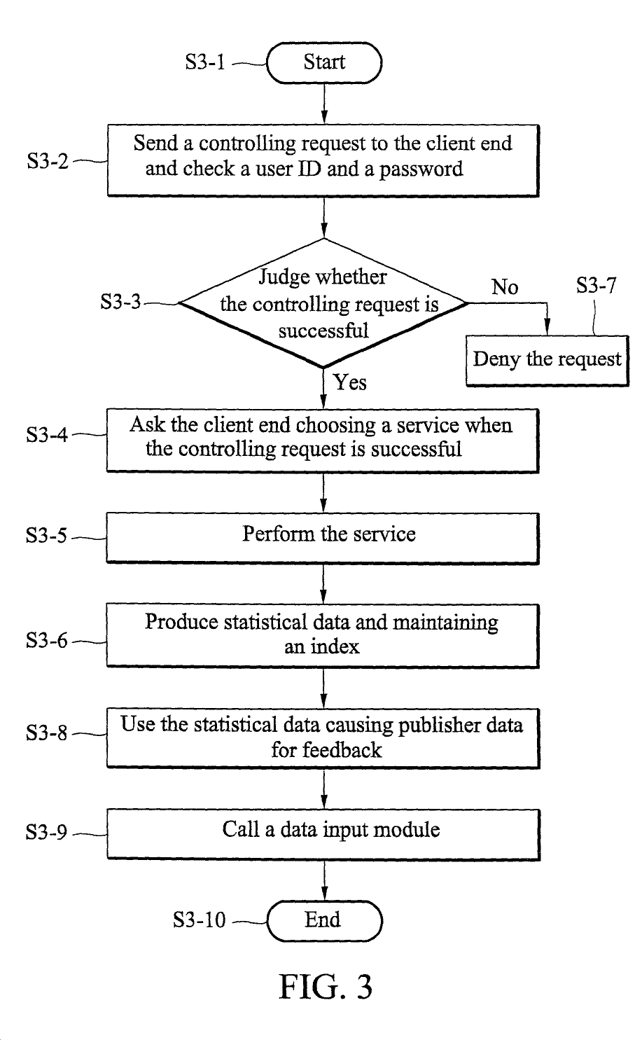

FIG. 3 illustrates a flow chart showing the steps for the server statistical & publishing module of the system in this invention. In step S3-2, the server statistical & publishing module sends a controlling request to the client end and checks a user ID and a password.

In step S3-3, the server statistical & publishing module judges whether the controlling request is successful. If the controlling request is successful, the server statistical & publishing module will execute step S3-4; otherwise execute step S3-7 to deny the request.

In step S3-4, the server statistical & publishing module asks the client end choosing a service when the controlling request is successful.

In step S3-5, the server statistical & publishing module performs the service.

In step S3-6, the server statistical & publishing module produces statistical data and maintains an index.

In step S3-8, the server statistical & publishing module uses the statistical data causing publisher data for feedback.

In step S3-9, the server statistical & publishing module calls a data input module.

In step S3-10, the server statistical & publishing module terminates.

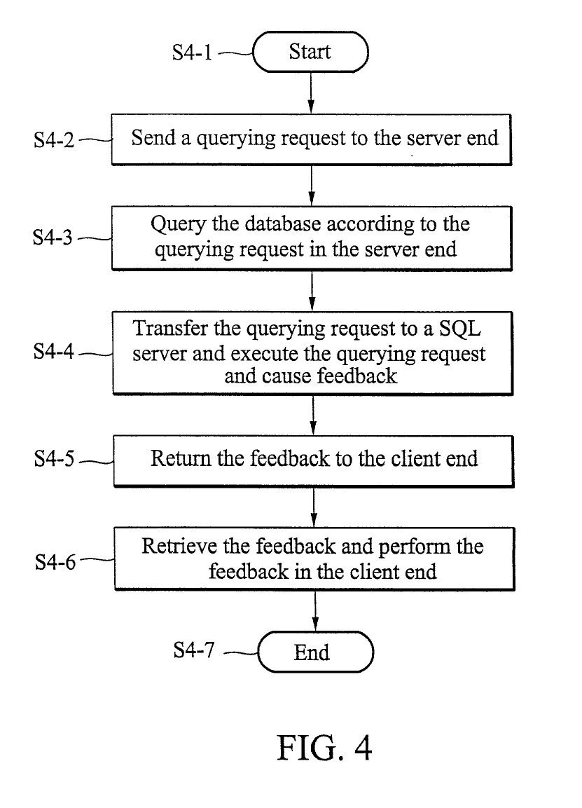

FIG. 4 illustrates a flow chart showing the steps for the client feedback receiving module of the system in this invention. In step S4-2, the client feedback receiving module sends a querying request to the server end.

In step S4-3, the client feedback receiving module queries the database according to the querying request in the server end.

In step S4-4, the client feedback receiving module transfers the querying request to a SQL server and executes the querying request, and causes feedback.

In step S4-5, the client feedback receiving module returns the feedback to the client end.

In step S4-6, the client feedback receiving module retrieves the feedback and performing the feedback in the client end.

In step S4-7, the client feedback receiving module terminates.

A client/server based dynamic information feedback method according to the preferred embodiment of the present invention will now be described.

A client/server based dynamic information feedback method according to the preferred embodiment comprises the steps of: (a) collecting data and sending the data from the client end; (b) receiving the data from the client end and analyzing the data on the server end; (c) calculating the data and resulting in statistical data, then storing the statistical data into a database on the server end; and (d) sending a request to the server end and causing feedback, then returning the feedback to the client end. The step (b) includes performing the server receiver & analyst module given above. The step (c) includes performing the server statistical & publishing module given above. The step of (d) includes performing the client feedback receiving module given above.

### EXAMPLE

The Distributing Preload Software Test is a example of a client/server based dynamic information feedback system of the present invention. The Distributing Preload Software Test is carried out as follows. The testing data of worldwide-distributed testing sites are compiled in a certain format. The data is then transferred via a network to a central server end having a security mechanism. After receiving the data, the server end analyzes the data and causes the data format that the server end can acknowledge. The server end categorizes and manages the data in a database and causes an inquiry information. Thus, the data can be centrally managed easily and the inquiry information can be obtained easily by the client end.

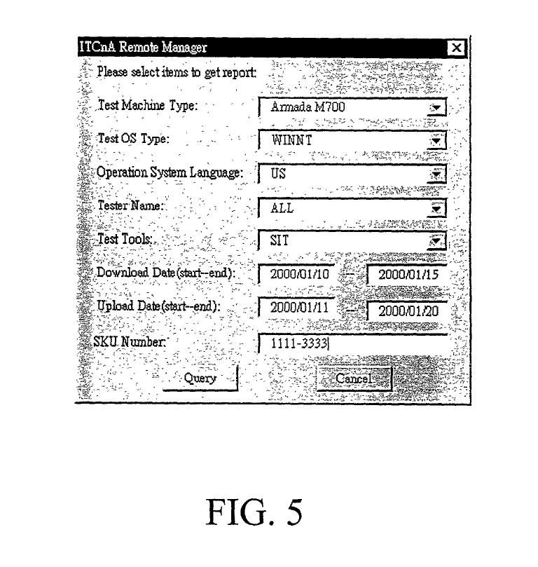

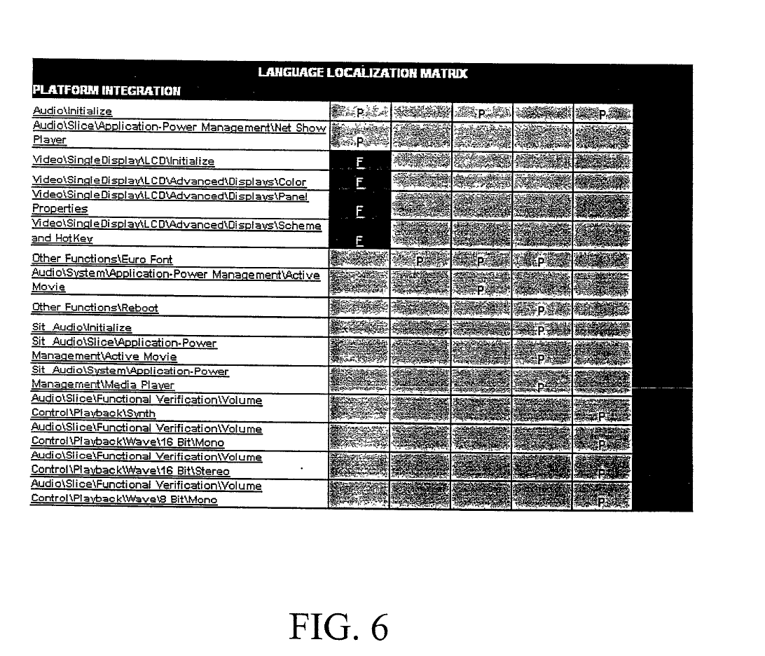

Referring to FIG. 5 a frame showing a client end sending a querying request to a server end in this example is illustrated. Referring to FIG. 6 a frame showing the server end sending a newest corresponding inquiry result to the client end in this example is illustrated.

While the invention has been described with reference to various illustrative embodiments, the description is not intended to be construed in a limiting sense. Various modifications of the illustrative embodiments, as well as other embodiments of the invention, will be apparent to those persons skilled in the art upon reference to this description. It is therefore contemplated that the appended claims will cover any such modifications or embodiments as may fall within the scope of the invention defined by the following claims and their equivalents.

What is claimed is:

1. A client/server based dynamic information feedback system comprising:
a client sender module, for collecting data and sending the data;
a server receiving & analysis module, for receiving the data and analyzing the data;
a server statistical & publishing module, for calculating the data and resulting in statistical data, then storing the statistical data into a database; and
a client feedback receiving module, sending a request to the server end and causing feedback, then returning the feedback to the client end.

2. The system as recited in claim 1, wherein the client sender module comprises sending the data to the server end with I-SQL function of a SQL server.

3. The system as recited in claim 1, wherein the server receiving & analysis module further comprises the steps of:
starting a database receiver in the server end;
receiving data;
analyzing the format of the data;
judging whether or not the data corresponds with a certain format;
opening a first packet of the data;
modifying the data; and
packing the modified data as a second packet that the database can acknowledge.

4. The system as recited in claim 1, wherein the server statistical &publishing module further comprises the steps of:
sending a controlling request to the client end and checking a user ID and a password;
judging whether the controlling request is successful;
asking the client end choosing a service when the controlling request is successful;
performing the service;
producing statistical data and maintaining an index;
using the statistical data causing publisher data for feedback; and
calling a data input module.

5. The system as recited in claim 1, wherein the client feedback receiving module further comprises the steps of:
sending a querying request to the server end;
querying the database according to the querying request in the server end;
transferring the querying request to a SQL server and executing the querying request, and causing feedback;
returning the feedback to the client end; and
retrieving the feedback and performing the feedback in the client end.

6. A client/server based dynamic information feedback method comprising the steps of:
(a) collecting data and sending the data from the client end;
(b) receiving the data from the client end and analyzing the data on the server end;
(c) calculating the data and resulting in statistical data, then storing the statistical data into a database on the server end; and
(d) sending a request to the server end and causing feedback, then returning the feedback to the client end.

7. The system as recited in claim 1, wherein the step of collecting data and sending the data from the client end comprises sending the data to the server end with I-SQL function of a SQL server.

8. The method as recited in claim 6, wherein the step (b) further comprises the steps of:
starting a database receiver in the server end;
receiving data;
analyzing the format of the data;
judging whether or not the data corresponds with a certain format;
opening a first packet of the data;
modifying the data; and
packing the modified data as a second packet that the database can acknowledge.

9. The method as recited in claim 6, wherein the step (c) further comprises the steps of:
sending a controlling request to the client end and checking a user ID and a password;
judging whether the controlling request is successful;
asking the client end choosing a service when the controlling request is successful;
performing the service;
producing statistical data and maintaining an index;
using the statistical data causing publisher data for feedback; and
calling a data input module.

10. The method as recited in claim 6, wherein the step (d) further comprises the steps of:
sending a querying request to the server end;
querying the database according to the querying request in the server end;
transferring the querying request to a SQL server and executing the querying request, and causing feedback;
returning the feedback to the client end; and retrieving the feedback and performing the feedback in the client end.
